(19) United States
(12) Patent Application Publication
(10) Pub. No.: US 2022/0035051 A1
(43) Pub. Date: Feb. 3, 2022

(54) INERTIAL NAVIGATION UNIT ENHANCED WITH ATOMIC CLOCK

(71) Applicant: Robotic Research, LLC, Clarksburg, MD (US)

(72) Inventors: Alberto Daniel LACAZE, Potomac, MD (US); Karl Nicholas MURPHY, Cocoa Beach, FL (US); Raymond Paul WILHELM, III, Gaithersburg, MD (US)

(21) Appl. No.: 17/382,823

(22) Filed: Jul. 22, 2021

Related U.S. Application Data
(63) Continuation of application No. 15/168,460, filed on May 31, 2016, now abandoned.
(60) Provisional application No. 62/167,723, filed on May 28, 2015.

(51) Int. Cl. G01S 19/47; G01S 19/21; G01S 19/35

(52) U.S. Cl. CPC G01S 19/47; G01S 19/45; G01S 19/35; G01S 19/215

(57) ABSTRACT

An atomic clock is used in conjunction with the GNSS receiver and the inertial sensors, creating a more capable inertial navigation system (INS). The system can be composed of a GNSS receiver, an accurate clock, and a mechanism for measuring relative pose changes. For example, the system can utilize an inertial measurement unit (IMU) to provide the relative pose changes, but other mechanisms, such as visual or LADAR odometry, can be used. The GNSS receiver measures the pseudo-ranges to the GNSS satellites in the field of view. These measurements are “time tagged” with the accuracy of the atomic clock. The relative motion between the pseudo-ranges is measured using the IMU. Finally, a lock is achieved by filtering these measurements. The filtering mechanism can be a traditional Kalman Filter or other mechanisms that attempt to minimize a mean square error.

### CROSS-REFERENCE TO RELATED APPLICATIONS

This application is a continuation of U.S. application Ser. No. 15/168,460, entitled “INERTIAL NAVIGATION UNIT ENHANCED WITH ATOMIC CLOCK,” filed May 31, 2016, which claims the benefit of U.S. Provisional Application No. 62/167,723, entitled “INERTIAL NAVIGATION UNIT ENHANCED WITH ATOMIC CLOCK”, filed on May 28, 2015, both of which are hereby incorporated by reference herein in their entireties.

### FIELD

The present application relates generally to inertial navigational units. More specifically, the present application relates to inertial navigation systems (INS) and units that utilize a combination of inertial sensors (accelerometers and gyroscopes) and Global Navigation Satellite System (GNSS) to find relative and absolute location.

### BACKGROUND

Inertial navigation units utilize a combination of inertial sensors (accelerometers and gyroscopes) and Global Navigation Satellite System (GNSS) to find relative and absolute location. GNSS includes a global positioning system (GPS), global navigation satellite system (GLONASS), GALILEO or other state and private satellites. There are a variety of published algorithms that describe, in detail, how to filter the measurements provided by the inertial sensors and the GNSS receiver. The inertial sensors provide relative localization, while GNSS provides an absolute frame of reference that helps the unit localize with respect to the world. The GNSS receiver senses sequences of known signals that are emitted by each satellite. Since these sequences travel close to the speed of light, the unit is capable of resolving its location by comparing the times between the received signals from the different satellites, and knowing the location of each satellite. A minimum of four pseudo-ranges to different satellites are necessary to fully solve (“get a lock”) for the localization (x,y,z) and time unknowns.

While the satellites have accurate atomic clocks, most modern GNSS receivers use less accurate quartz clock. Quartz clocks—though accurate for most applications—have significant drift when used to measure the minute times required to localize by these signals (travelling close to the speed of light). In other words, the four pseudo-range measurements need to be taken in very close time proximity by a GNSS receiver, before they can be used to solve for the “lock”. When compared to the speed of light, quartz clocks can drift as much as 150 m/s, and therefore, waiting one second between these four measurements can add 150 m to the error of the location solution.

Unfortunately, this means that in order to “get a lock,” conventional GNSS systems need to have full view of at least four GNSS satellites at a given moment of time. This is relatively easy to do in open areas but it is significantly harder in big cities, where occlusions can mask significant areas of the sky.

### SUMMARY

Atomic clocks are very accurate clocks that provide very low drift rates with orders of magnitude more accurate than quartz (or other clocks technologies). In embodiments, an atomic clock is used in conjunction with the GNSS receiver and the inertial sensors, creating a more capable Navigation System. As opposed to current navigation units, which require line of sight to four satellites simultaneously, embodiments can produce a lock by acquiring individual pseudo-ranges at different times, and solving for the lock by utilizing the accurate time tags provided by the atomic clock. This becomes important in urban scenarios, where different parts of the sky are blocked at different times.

### BRIEF DESCRIPTION OF THE DRAWINGS

The accompanying drawings, which are incorporated herein and form a part of the specification, illustrate embodiments and, together with the description, further serve to explain the principles of the disclosed subject matter and to enable a person skilled in the pertinent art to make and use the disclosed subject matter.

FIG. 1A illustrates a GNSS with a quartz clock requires 4 satellites to get a lock.

FIG. 1B illustrates four satellites, at one time, are hard to achieve in an urban scenario.

FIG. 1C illustrates the proposed atomic clock enabled system can get a fix by using separate measurements to different satellites performed at different times.

FIG. 2 is a flow chart illustrating the components and connectivity of the components of an embodiment.

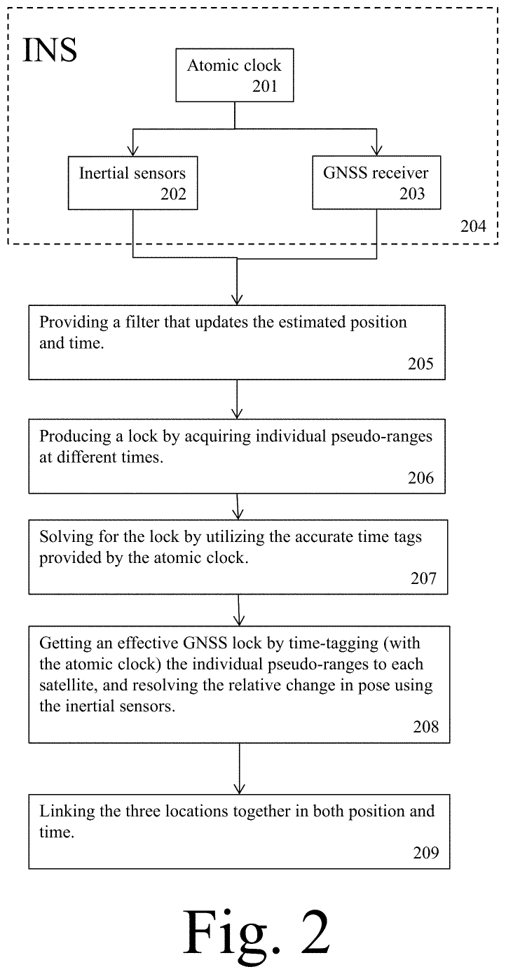

FIG. 3 is a flow chart illustrating the process and method of the system of an embodiment.

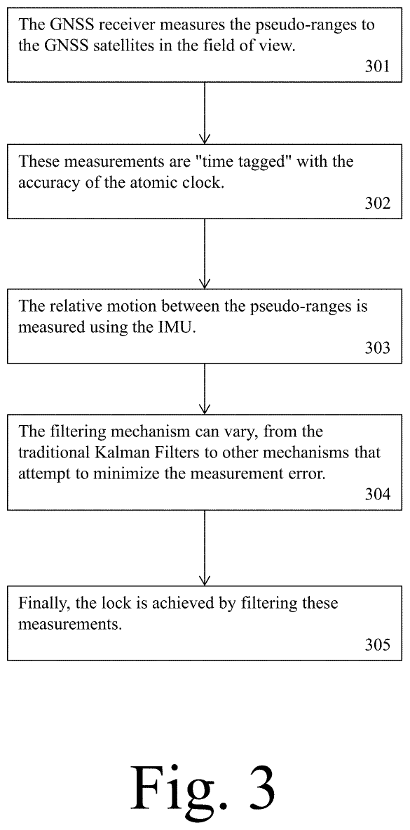

### DETAILED DESCRIPTION

### I. Definitions

An atomic clock is a clock device that uses an electronic transition frequency in the microwave, optical, or ultraviolet region of the electromagnetic spectrum of atoms as a frequency standard for its timekeeping element. Atomic clocks are the most accurate time and frequency standards known, and are used as primary standards for international time distribution services, to control the wave frequency of television broadcasts, and in global navigation satellite systems such as GPS.

An inertial navigation system (INS) is a navigation aid that uses a computer, motion sensors (accelerometers) and rotation sensors (gyroscopes) to continuously calculate via dead reckoning the position, orientation, and velocity (direction and speed of movement) of a moving object without the need for external references. It can also use other motion sensors such as wheel odometers. INS is used on vehicles such as ships, aircraft, submarines, guided missiles, and spacecraft. Other terms used to refer to inertial navigation systems or closely related devices include inertial guidance system, inertial reference platform, inertial instrument, inertial measurement units (IMU) and many other variations.

GALILEO is the global navigation satellite system (GNSS) that is currently being created by the European Union (EU) and European Space Agency (ESA), headquartered in Prague in the Czech Republic, with two ground operations centers, Oberpfaffenhofen near Munich in Germany and Fucino in Italy.

LADAR (also known as LIDAR) is an optical remote sensing technology that can measure the distance to, or other properties of a target by illuminating the target with light, often using pulses from a laser. LIDAR technology has application in geomatics, archaeology, geography, geology, geomorphology, seismology, forestry, remote sensing and atmospheric physics, as well as in airborne laser swath mapping (ALSM), laser altimetry and LIDAR contour mapping. The acronym LADAR (Laser Detection and Ranging) is often used in military contexts. The term “laser radar” is sometimes used, even though LIDAR does not employ microwaves or radio waves and therefore is not radar in the strict sense of the word.

In computing, a graphical user interface (GUI, commonly pronounced gooey) is a type of user interface that allows users to interact with electronic devices using images rather than text commands. GUIs can be used in computers, hand-held devices such as MP3 players, portable media players or gaming devices, household appliances and office equipment. A GUI represents the information and actions available to a user through graphical icons and visual indicators such as secondary notation, as opposed to text-based interfaces, typed command labels or text navigation. The actions are usually performed through direct manipulation of the graphical elements.

The terms location and place in geography are used to identify a point or an area on the Earth's surface or elsewhere. The term location generally implies a higher degree of certainty than place, which often indicates an entity with an ambiguous boundary, relying more on human/social attributes of place identity and sense of place than on geometry.

An “absolute location” is designated using a standard geographic coordinate system such as a specific pairing of latitude and longitude, or a Cartesian coordinate grid, for example, a Spherical coordinate system or an ellipsoid-based system such as the World Geodetic System, or similar methods. Absolute location, however, is a term with little real meaning, since any location must be expressed relative to something else. For example, longitude is the number of degrees east or west of the Prime Meridian, a line arbitrarily chosen to pass through Greenwich, London. Similarly, latitude is the number of degrees north or south of the Equator. Because latitude and longitude are expressed relative to these lines, a position expressed in latitude and longitude is actually a relative location.

A “relative location” is described as a displacement from another site where the site is typically not located on a standard geographic coordinate system. For example, the site could be located where the system was turned on.

A satellite navigation or satnav system is a system of satellites that provide autonomous geo-spatial positioning with global coverage. It allows small electronic receivers to determine their location (longitude, latitude, and altitude) to high precision (sub meters) using time signals transmitted along a line of sight by radio from satellites. The signals also allow the electronic receivers to calculate the current local time to high precision, which allows time synchronization. A satellite navigation system with global coverage may be termed a global navigation satellite system (GNSS).

### II. Description

In the following description of exemplary embodiments, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

Atomic clocks 201 are very accurate clocks that provide very low drift rates with orders of magnitude more accurate than quartz (or other clocks technologies).

In an embodiment, an atomic clock 201 is used in conjunction with the GNSS receiver 203 and the inertial sensors 202, creating a more capable INS 204. As opposed to current navigation units, which require line of sight to four satellites simultaneously, embodiments can produce a lock by acquiring individual pseudo-ranges at different times 206, and solving for the lock by utilizing the accurate time tags 207 provided by the atomic clock 201.

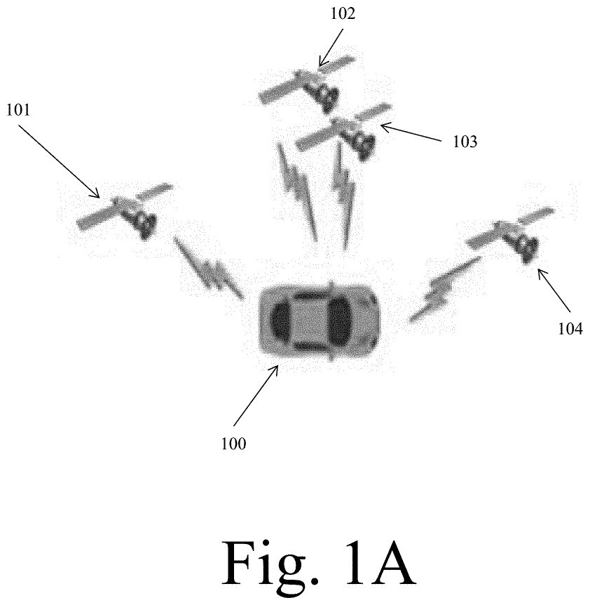

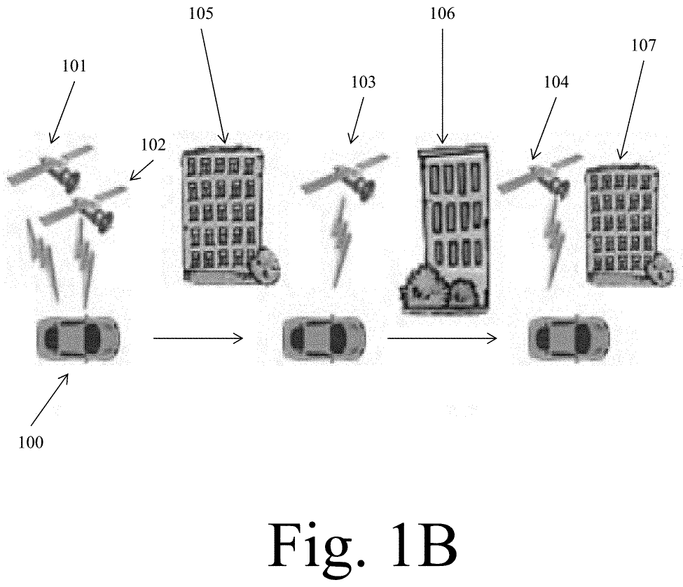

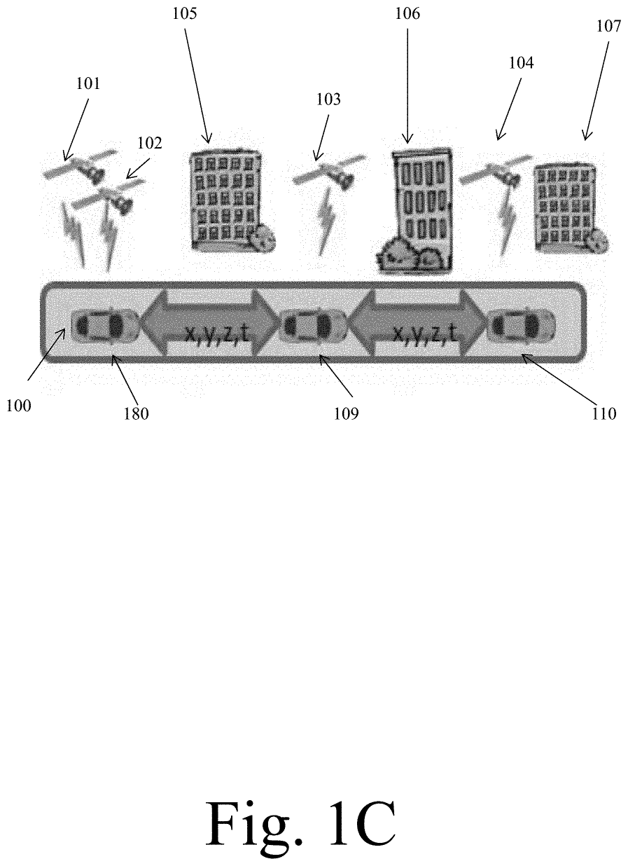

This becomes important in urban scenarios, where different parts of the sky are blocked at different times by obstructions 105, 106, and 107. For example, in FIG. 1A, when the receiver 100 has line of sight to four satellites 101, 102, 103, and 104, it can obtain a GNSS fix, but if the sky is partially blocked, as in FIG. 1B a traditional GNSS receiver is not capable of providing a lock, even though it has been able to get line of sight to four satellites, although at different times and locations as the car moves down a city street and through various obstructions 105, 106, and 107. The quartz clock drifted too much between measurements to be able to provide an accurate lock.

In FIG. 1C, an embodiment is capable of getting an effective GNSS lock by time-tagging (with the atomic clock) the individual pseudo-ranges to each satellite 101, 102, 103, and 104, and resolving the relative change in pose using the inertial sensors 208. The three locations 108, 109, and 110 are linked together in both position and time 209.

In addition, the embodiment does not need to wait see four satellites to get an update. Instead, the inertial measurements, the atomic clock signal, and any GNSS signal(s) can be feed into a filter that updates the estimated position and time 205.

Advantages of embodiments from a lock standpoint: clear line of sight can be one satellite at a time, as opposed to the current four-at-a-time requirement. Only three satellites are necessary if absolute time is measured at a previous time by the atomic clock. Only three satellites are necessary if elevation is known (barometer or other means). Only two satellites are necessary if elevation and absolute time are known.

Other advantages: Having an atomic clock 201 on the receiver 100 will make it significantly harder to spoof the receiver. The “spoofer” will need to know absolute time and an accurate location of the GNSS unit, in order to create the spoofing signal. Even under those conditions, spoofing becomes significantly more complicated. Having an onboard atomic clock 201 allows for the synchronization of other sensors, like RADAR, from multiple vehicles.

The system is composed of a GNSS receiver, an accurate clock, and a mechanism for measuring relative pose changes. Currently, atomic clocks are the most capable technology that provides the required accuracy; however, it is likely that, in the future, other accurate clock technologies will be implemented. The system being presented utilizes an inertial measurement unit (IMU) to provide the relative pose changes, but other mechanisms can be used, like visual and LADAR odometry.

The GNSS receiver measures the pseudo-ranges to the GNSS satellites in the field of view 301. These measurements are “time tagged” with the accuracy of the atomic clock 302. The relative motion between the pseudo-ranges is measured using the IMU 303. Finally, the lock is achieved by filtering these measurements 305. The filtering mechanism can vary, from the traditional Kalman Filters to other mechanisms that attempt to minimize the measurement error 304.

Although, in this write-up, the GNSS receiver has been treated separately from the atomic clock, it is clear that these two systems can be combined.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

1-19. (canceled)

20. A computer system for providing absolute and relative localization, including obtaining a location lock without simultaneous view of satellites, comprising:
a computer;
an atomic clock in communication with the computer;
an Inertial Measurement Unit (IMU) in communication with the computer; and
a GNSS receiver in communication with the computer;
wherein the computer is configured to execute software to:
tag, with a first time of the atomic clock, a first pseudo-range measured by the GNSS receiver with respect to a first satellite;
tag, with a second time of the atomic clock, a second pseudo-range measured by the GNSS receiver with respect to a second satellite;
tag, with a third time of the atomic clock, a third pseudo-range measured by the GNSS receiver with respect to a third satellite;
compute at least one relative change in position based on data measured by the IMU between the first, second, and third times; and
compute an absolute location based on (i) the first, second, and third pseudo-ranges, (ii) differences between the first, second, and third times, and (iii) the at least one relative change in position,
wherein at least one of the first, second, and third times is different from another of the first, second, and third times.

21. The computer system of claim 20, wherein:
the computer system is part of a first vehicle, and
the computer is further configured to execute the software to:
receive measurements from a second vehicle; and
calculate a relative position between the first and second vehicles using a GNSS filtering process.

22. The computer system of claim 21, wherein the received measurements comprise an accurate time and wherein the calculation of the relative position between the first and second vehicles is based at least in part on the accurate time.

23. The computer system of claim 21, wherein the received measurements are acquired from at least one of visual odometry and LADAR odometry that measures the relative position between the first and second vehicles.

24. The computer system of claim 20, wherein the first, second, and third times are absolute time values, and wherein the computer is further configured to execute the software to:
use the absolute time values measured by the atomic clock to compute the absolute location using no more than three measured pseudo-ranges.

25. The computer system of claim 20, wherein:
the computer is further configured to execute the software to measure an elevation; and
the computing of the absolute location is further based on the elevation.

26. A computer system for providing absolute and relative localization, including obtaining a location lock without simultaneous view of multiple satellites, comprising:
a computer;
an atomic clock in communication with the computer;
an elevation measurement device in communication with the computer;
an Inertial Measurement Unit (IMU) in communication with the computer; and
a GNSS receiver in communication with the computer;
wherein the computer is configured to execute software to:
tag, with a first time of the atomic clock, a first pseudo-range measured by the GNSS receiver with respect to a first satellite;
tag, with a second time of the atomic clock, a second pseudo-range measured by the GNSS receiver with respect to a second satellite;
compute a relative change in position based on data measured by the IMU and on data measured by the elevation measurement device between the first and second times; and
compute an absolute location based on (i) the first and second pseudo-ranges, (ii) a difference between the first and second times, and (iii) the relative change in position.

27. The computer system of claim 26, wherein the first and second satellites comprise the same satellite in view at each of the first and second times.

28. The computer system of claim 26, wherein the first and second times are absolute time values, and wherein the computer is further configured to execute the software to:
use the absolute time values measured by the atomic clock to compute the absolute location using no more than two measured pseudo-ranges.
